(19) United States
(12) Patent Application Publication
(10) Pub. No.: US 2013/0111511 A1
(43) Pub. Date: May 2, 2013

(54) METHODS AND APPARATUS TO PUBLISH A PROGRAMMING SCHEDULE

(71) Applicant: Jan Besehanic, Tampa, FL (US)

(72) Inventor: Jan Besehanic, Tampa, FL (US)

(21) Appl. No.: 13/282,928

(22) Filed: Oct. 27, 2011

(51) Int. Cl. H04N 21/482; H04H 60/32

(52) U.S. Cl. 725/14; 725/50; 725/46; 725/42

(57) ABSTRACT

Example methods, apparatus, systems, and computer-readable storage media to publish a programming schedule. An example method includes, if a current geographic location of a mobile device associated with a user is different than a home geographic location, determining a broadcast time and a channel schedule when a program of interest to the user is to be presented in the current location, the program of interest identified while the user is in the home location. The example method includes pushing the broadcast time and an identifier of the broadcast channel of the program to the mobile device.

### FIELD OF THE DISCLOSURE

The present disclosure relates generally to broadcasting and, more particularly, to methods and apparatus to publish a programming schedule.

### BACKGROUND

Audience measurement of broadcast media, such as television and/or radio, is typically carried out by monitoring media exposure of panelists that are statistically selected to represent particular demographic groups. Using various statistical methods, the captured media exposure data is processed to determine the size and demographic composition of the audience(s) for programs of interest. The audience size and demographic information is valuable to advertisers, broadcasters and other entities. For example, audience size and demographic information is a factor in the placement of advertisements, as well as a factor in valuing commercial time slots during a particular program.

### BRIEF DESCRIPTION OF THE DRAWINGS

FIG. 1 illustrates an example system implemented in accordance with the teachings of this disclosure to publish a programming schedule.

FIG. 2 illustrates an example implementation of the schedule notifier of FIG. 1.

FIG. 3 illustrates an example implementation of the media supplier of FIG. 1.

FIG. 4 is a flow diagram representative of example machine readable instructions that may be executed to implement the example registrar of FIG. 2.

FIG. 5 is a flow diagram representative of example machine readable instructions that may be executed to implement the example schedule notifier of FIG. 2.

FIG. 6 is a flow diagram representative of example machine readable instructions that may be executed to implement the example media supplier of FIG. 3.

FIG. 7 is a block diagram of an example processor platform that may be used to execute the instructions of FIGS. 4, 5 and/or 6 to implement the example registrar of FIG. 2, the example schedule notifier of FIG. 2, and/or the example media supplier of FIG. 3.

### DETAILED DESCRIPTION

Audience measurement companies request persons to participate in panels. Such persons agree to allow the audience measurement entity to measure their exposure to media (e.g., television, radio, Internet, websites, advertising, signage, outdoor advertising, etc.). In order to increase the size of a panel, to retain persons in a panel, and/or to encourage a person to join a panel, an audience measurement entity may wish to provide an incentive.

Example methods, apparatus, systems, and/or computer-readable storage media disclosed herein incentivize a person to join and/or remain in an audience measurement panel by publishing programming schedules of interest to the panelist when the panelist travels to a new broadcasting area. For instance, disclosed example methods include, if a current geographic location of a mobile device associated with a user is different from a home geographic location, determining a broadcast time and a channel schedule when a program of interest to the user is to be presented in the current location, the program of interest identified while the user is in the home location (e.g., when the user was in his/her “home” broadcast area); and pushing the broadcast time and an identifier of the broadcast channel of the program to the mobile device.

A disclosed example system includes a geographic location identifier to determine a current geographic location of a mobile device associated with a user; a schedule identifier to determine a broadcast time and a channel on which a program of interest is to be broadcast in the current geographic location, the current location being different from the home location; and a schedule pusher to push the broadcast time and an identifier of the broadcast channel of the program to the mobile device.

A disclosed example computer-readable storage medium comprises instructions that, when executed, cause a computing device to at least, if a geographic location of a mobile device associated with a user is different from a home geographic location, determine a broadcast time and a channel schedule when a program of interest to the user is to be presented, the program of interest identified while the user is in the home location (e.g., when the user was in his/her “home” broadcast area); and push the broadcast time and an identifier of the broadcast channel of the program to the mobile device.

In examples disclosed herein, a schedule notifier determines a current geographic location of a mobile device associated with a user. The schedule notifier uses the location to determine a broadcast schedule for a program of interest (e.g., a television program) identified by the user if the geographic location associated with a broadcast area is different than a home broadcast area. The schedule notifier relays this information to the user via the mobile device. To utilize this example system, the user is asked and/or required to provide media information, such as, for example, media exposure data or demographic information. Such information is useful for assessing audience exposure to media and/or audience composition determinations. Media exposure data and demographic information are valuable to advertisers, broadcasters, etc. in considering advertisement placement and/or commercial time slot value.

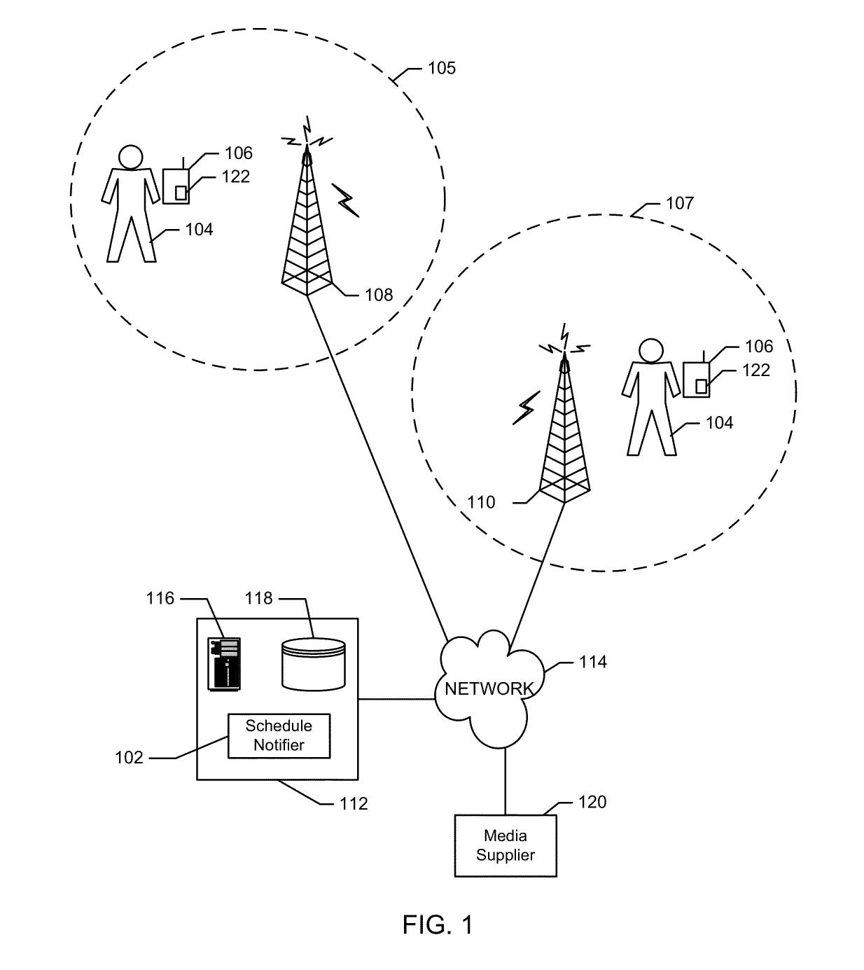

FIG. 1 illustrates an example schedule notifier 102 to publish a programming schedule to a user 104 in an example environment of use. In the example of FIG. 1, the example schedule notifier 102 determines a current geographic location of a mobile device 106 associated with the user 104. The geographic location can be determined based on, for example, a global positioning system (“GPS”), a cellular system, or any other past, present or future locating technology. Based on the location of the user 104, the schedule notifier 102 determines a local broadcast time and a local channel schedule when a program previously identified by the user 104 is to be presented. For example, the user is assumed to live in a first geographic area 105 (e.g., referred to here as a home geographic area and/or location) which is serviced by a first broadcast area (e.g., referred to here as a home broadcast area and/or location). The first geographic area and the first broadcast area of the instant example are co-extensions and, thus, are referred to with the reference numeral 105. If the user travels to a second, different geographic area and/or location 107 serviced by a second, different broadcast area and/or location, the time and/or channels on which the program(s) are broadcast may change. The second geographic area and the second broadcast area of the instant example are co-extensions and, thus, are referred to with the same reference numeral 107. The schedule notifier 102 of the illustrated examples automatically prepares the user for such changes by automatically pushing a broadcast time and an identifier of a broadcast channel on which the program is to be broadcast in the second, different geographic area to the mobile device 106.

In the example of FIG. 1, the user 104 is asked and/or required to register with an audience measurement entity associated with the schedule notifier 102. By registering with the audience measurement entity, the user 104 provides permission to monitor exposure to media. Such media exposure may be tracked using the mobile device 106 and a meter 122 installed on the mobile device 106 of the panelist 104. The audience measurement entity may download the meter 122 to the mobile device 106 to monitor exposure to media. The meter 122 may monitor, for example, media presented (e.g., via the device 106) on or near (e.g., in proximity to) the mobile device 106 such as radio programs, music, television programs, movies, and/or advertisements. The meter 122 of the illustrated example collects identifications (e.g., program identification codes and/or signatures) of media which the mobile device 106 has been exposed to. The media and/or identifications of the media are forwarded to a central facility 112. The central facility 112 records media exposure data from the mobile device 106 in a database in association with an identifier of the mobile device 106 to facilitate matching to the user demographic data. The recorded media exposure data may then be analyzed and/or processed to determine the size and/or demographic composition of an audience for a particular television program.

As used herein, a code is data added to media. A code may be added for the purpose of program identification as is done by many broadcasters in the United States which insert codes (sometimes referred to as watermarks) into the audio of broadcast media using encoding technology provided by The Nielsen company or may be inserted for some other purpose (e.g., Packet Identification (PID) headers used to multiplex digital broadcast streams). As used herein, a signature is a representation of some inherent characteristic of some aspect of the media (e.g., an aspect of the spectral composition of an audio portion of media, etc). Codes or signatures may be present in any portion of the media signal (e.g., in the audio, in the video, in control data broadcast with the media signal, etc). This disclosure can employ any sort of past, present and/or future media identification technology.

Although the example of FIG. 1 employs a meter 122 in the mobile device 106, one or more additional meters (e.g., a stationary, in-home meter), may likewise be employed.

To enable the schedule notifier 102 to push information of interest to the user 104, the user 104 of the illustrated example is asked to provide and/or identify a program (e.g., an audio or television program) of interest. For example, the user 104 may provide a title of a program of interest by typing in a title, selecting a title from a list, etc. Additionally or alternatively, the user may provide and/or select an episode name of a program and/or a name of an actor of interest. In other examples, the user 104 need not provide such information as the user's media exposure habits are identified by the meter 122. The schedule notifier 102 of the illustrated example publishes a programming schedule of the program(s) of interest to the user 104 via the mobile device 106 when the user moves to a different broadcast area. Pushing broadcast time(s) and identifier(s) of broadcast channel(s) for the program(s) of interest provides an incentive for the user 104 to participate in an audience measurement panel. Expanding a panel size by adding and/or retaining panelists has significant value to an audience measurement company and its clients.

In the illustrated example, to determine the current geographic location of the mobile device 106, the meter 122 downloaded to the mobile device 106 requests the mobile device 106 to access and/or generate geographic location values. The mobile device 106 may use GPS techniques to determine its location. In the illustrated example, the geographic location values generated by the mobile device 106 are GPS values which are periodically or aperiodically transmitted to the schedule notifier 102. In some examples, the location data is transmitted to the schedule notifier 102 whenever a sufficient change of location is detected (e.g., by comparing a current location to a home location). A sufficient change of location may be, for example, a distance of 5 miles. In some examples, the location of the mobile device 106 is determined using, for example, triangulation based on the radio frequency (“RF”) transceiver towers 108 and 110 (e.g., cellular phone towers). In other examples, the change of location is not detected using location values. Instead, the meter 122 detects the change by identifying a different set of broadcast channels (e.g., television channels) and/or different strength(s) of such signal(s) that are present at the new location. For example, if there are three stations broadcasting in the home location at frequencies X, Y and Z, and the meter 122 detects a different number of stations (e.g., more stations or less stations), and/or if the stations detected by the meter 122 are broadcasting on one or more different frequencies, then the meter 122 may determine that a new location has been entered. In such examples, the user 104 may be prompted to enter a current location in response to such a determination or the meter 122 may determine the current location by a database reflecting set of stations and/or frequencies to be expected in certain geographic areas.

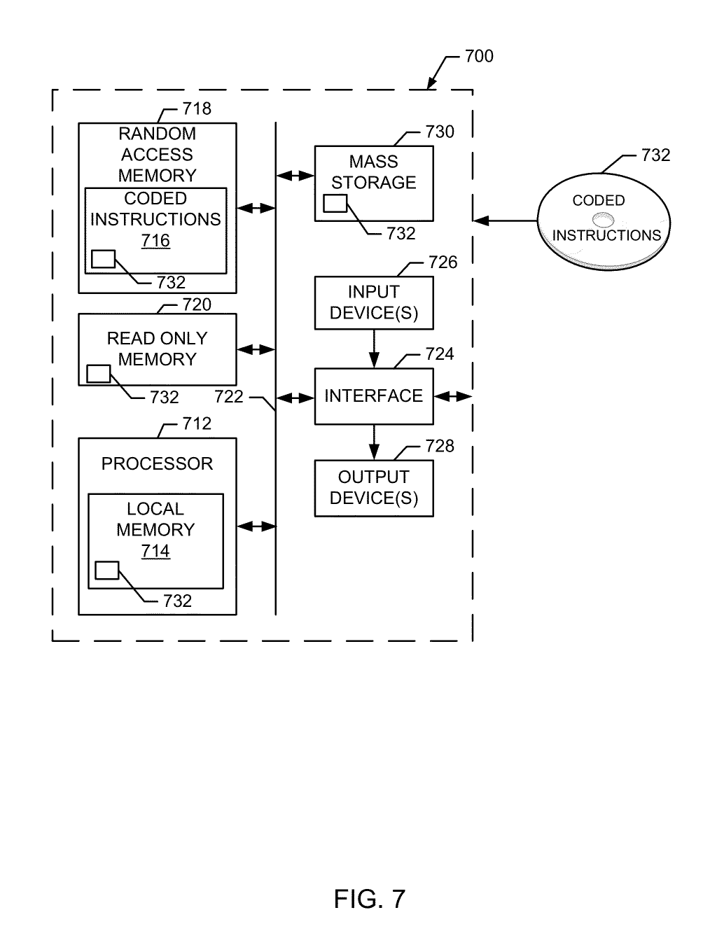

In the illustrated example, the meter 122 of the mobile device 106 communicates location information to the schedule notifier 102 and this schedule notifier 102 is located in the central facility 112. The central facility 112 of the illustrated example is communicatively coupled to the mobile device 106 via a network 114. The central facility 112 of the illustrated example collects and/or stores, for example, media exposure data, media monitoring data, and/or location information from various media monitoring devices such as, for example, the meter 122 of the mobile device 106. The central facility 112 may be, for example, a facility associated with The Nielsen Company (US), LLC or any affiliate of The Nielsen Company (US), LLC. The central facility 112 of the illustrated example includes a server 116 and a database 118 that may be implemented using any suitable processor, memory and/or data storage apparatus such as that shown in FIG. 7.

The network 114 of the illustrated example is used to communicate information between the central facility 112 and the mobile device 106 via the RF transceiver towers 108 and 110. Alternatively, the network 114 may be implemented using any suitable communication interface including, for example, one or more of telephone lines, a cable system, a satellite system, a cellular communication system, AC power lines, the Internet, etc.

In the illustrated example, if the schedule notifier 102 determines that the mobile device 106 is located in a location 107 different than the home location 105 (e.g., a location serviced by a different broadcast area 107 than the home broadcast area 105 such as, for example, the location 105 associated with RF transceiver tower 108, for example, Chicago), the schedule notifier 102 determines a local broadcast time and a local channel schedule when the program(s) identified by the user 104 are to be presented (e.g., broadcast) in the current location 107. For example, if the television program “Law and Order” is of interest to the user 104, the schedule notifier 102 of the illustrated example determines that “Law and Order” will be presented in Chicago on Channel 4 at 5:00 P.M. CST and provides this schedule information to the user 104 through, for example, an electronic mail message (“email”), a pop-up window, a calendar alert, a text message and/or any other type of notification medium. (In some examples, a notification is not provided when the user 104 is in the home location 105.) If the user 104 of the illustrated example travels to a second location 107 associated with RF transceiver tower 110 (for example, Los Angeles), the schedule notifier 102 determines that “Law and Order” will be presented on Channel 2 at 3:00 P.M. PST and provides this schedule information to the user 104 through, for example, an email, a pop-up window, a calendar alert, a text message and/or any other type of notification medium.

As mentioned above, after local broadcast time(s) and local channel schedule(s) for the program(s) of interest are determined, the schedule notifier 102 pushes this information to the mobile device 106 via the network 114. The presentation information may be displayed on the mobile device 106 without any user 104 interaction via, for example, a pop-up window and/or a calendar alert. In an alternative example, the schedule notifier 102 may send a message, such as a text message or an email, containing the presentation information to the user 104. The schedule notifier 102 of the illustrated example pushes the broadcast time(s) and identifier(s) of channel(s) to the mobile device 106 prior to the broadcast of the program of interest. For example, the schedule notifier 102 of the illustrated example pushes the schedule information to the user 104 fifteen minutes prior to the airing of the identified program. Other push times may, additionally or alternatively, be employed.

Additionally, the schedule notifier 102 of the illustrated example uses a media supplier 120 to select media related to the program(s) identified by the user 104 and provides advertisements related to the media and/or links to the media to the mobile device 106. Media related to the program may include other programs, advertisements, coupons, trivia, and/or special offers, etc. such as, for example, a discount coupon for purchasing a recorded season of the program of interest (e.g., “Law and Order”). Such advertisements may relate to products or services in the current location (e.g., area 107) and/or the home location (e.g., area 105).

Additionally or alternatively, the schedule notifier 102 of the illustrated examples uses the media supplier 120 to select media based on user 104 preference(s). For example, the user preference(s) may be based on previously identified programs, genres of previously identified programs, previously identified actors of interest, etc. Media based on the user preference(s) may be, for example, a program, a movie, and/or an advertisement for a new film being released. In the illustrated example, the media supplier 120 selects and/or stores media to be provided to the user 104 via the mobile device 106. In the example of FIG. 1, the media supplier 120 is remotely located from the schedule notifier 102 and the central facility 112. In alternative examples, the media supplier 120 is located in the central facility 112 and/or combined with the schedule notifier 102.

To provide the selected media (e.g., advertisements) to the user 104, the media supplier 120 of the illustrated example may provide the mobile device 106 with a uniform resource locator (“URL”) of a website, stream the media, and/or send an email containing the URL to the user 104 via the mobile device 106. The media supplier 120 may send the media, send an identifier of the media, send an offer to sell the media, and/or send a link to the media to the mobile device 106 before, during, or after, for example, the presentation of the program of interest. In alternative examples, the media supplier 120 provides the media, an identifier of the media, an offer to sell the media, and/or a link to the media to the schedule notifier 102 and the schedule notifier 102 sends the media, the identifier (e.g., a URL) of the media, the offer to sell the media, and/or the link to the media to the mobile device 106.

Other example methods and apparatus to provide secondary media content in association with primary broadcast media content are disclosed in U.S. patent application Ser. No. 12/771,640, entitled “Methods, Apparatus and Articles of Manufacture to Provide Secondary Content in Association with Primary Broadcast Media Content,” which was filed Apr. 30, 2010, which is hereby incorporated by reference in its entirety.

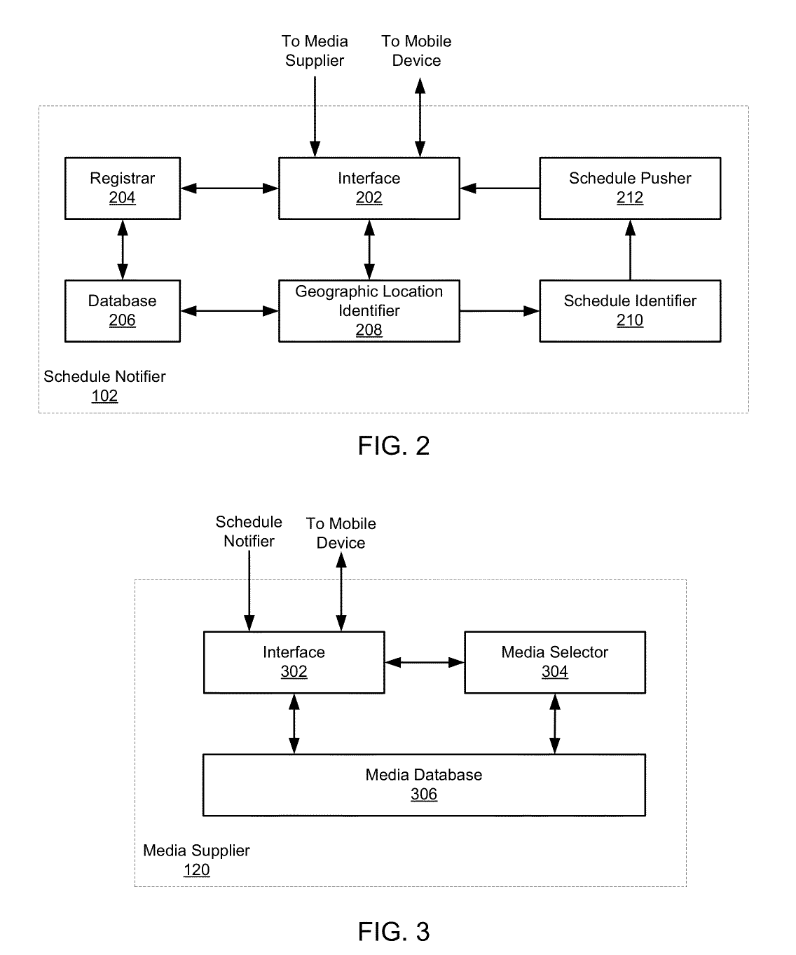

FIG. 2 is a block diagram of an example implementation of the schedule notifier 102 of FIG. 1. As described above, the meter 122 of the illustrated example determines a current location of a mobile device (e.g., the mobile device 106 of FIG. 1) associated with a user (e.g., the user 104 of FIG. 1). The meter 122 may, for example, make this determination by interacting with GPS functionality native to the mobile device. Based on the location, the schedule notifier 102 of the illustrated example determines and publishes a local broadcast time and a local channel schedule when a media program identified by the user 104 is to be presented. In some examples, the schedule notifier 102 determines and publishes a broadcast schedule only when the user 104 is not in a home area (e.g., area 105) or only when the user 104 changes areas. As shown in FIG. 2, the example schedule notifier 102 includes an interface 202, a registrar 204, a database 206, a geographic location identifier 208, a schedule identifier 210, and a schedule pusher 212.

The interface 202 of the illustrated example is used to facilitate communication between the schedule notifier 102 and one or more of the mobile device 106 and/or the media supplier 120 via the network 114 of FIG. 1. The registrar 204 of the illustrated example is provided to collect and store the demographic information of panelists, such as the user 104. The registrar 204 may, for example, obtain such demographic information when the user(s) sign up to be panelist(s). The registrar 204 may assign user identifiers to panelists and/or their mobile devices and may initiate the download of the meter 122 to the mobile devices. Example methods and apparatus to provide downloadable meters associated with mobile devices are disclosed in U.S. patent application Ser. No. 11/405,067, entitled “Portable Multi-Purpose Audience Measurement System,” which was filed Apr. 17, 2006, which issued as U.S. Pat. No. 7,587,732 on Sep. 8, 2009, and which is hereby incorporated by reference in its entirety.

The registrar 204 of the illustrated example interacts with the user 104 during the registration process via the interface 202. For example, the registrar 204 may receive permission from the user 104 to monitor exposure to media with the mobile device 106 (and/or one or more additional or alternative meters and/or devices). In the illustrated examples, the registrar 204 initiates downloading of the meter to the mobile device 106 upon completion of the registration process. The registrar 204 of the illustrated example also collects demographic information from the user 104 via the interface 202 and stores the information and/or data in the database 206. The database 206 of the illustrated example records the demographic information and/or media exposure data for the user 104 in association with the identifier of the mobile device 106 and/or the user 104 assigned in by the registrar 204.

The registrar 204 of the illustrated example receives identifier(s) of program(s) of interest from the user 104 via the interface 202. The received identifier(s) may identify a name of a program and/or may include other identifying information, such as a name of an episode of a program and/or a name of an actor. The registrar 204 of the illustrated example sends the identifier(s) of the program(s) to the database 206 to record the program(s) to be tracked by the schedule notifier 102. For example, a user may register and/or identify a program to be tracked at the time of registering to participate in a panel and/or may later identify program(s) to be tracked. In other examples, the user 104 is not is not expected to identify program(s) of interest and such program(s) are instead identified via the viewing data collected with the meter(s) 122.

The geographic location identifier 208 of the illustrated example is used in association with the meter 122 to determine a current geographic location (e.g., location 105 or 107) of the mobile device 106 associated with the user 104 and/or to determine if the current geographic location of the mobile device 106 is different than a home location (e.g., area 105). In the illustrated example, to determine the location of the mobile device 106, the location identifier 208 communicates, via the interface 202, with the meter 122, and the meter 122 requests the mobile device 106 to access and/or generate GPS values. In the illustrated example, the GPS values generated by the mobile device 106 are transmitted periodically or aperiodically to the location identifier 208 via the interface 202 without prompting from the schedule notifier 102. In other examples, the location information is transmitted in response to a request from the schedule notifier 102. In other examples, the location information is not provided to the schedule notifier 102. Instead, a message indicating a change to a new location (which may be identified in the message) is sent. In some examples, the location information is sent whenever a sufficient change of location is detected (e.g., by comparing a current location to a home location). In some examples, the location of the mobile device 106 is determined using, for example, triangulation based on, for example, one or more of the RF transceiver towers 108 and 110 of FIG. 1. In the illustrated example, the location information is sent from the location identifier 208 to the schedule identifier 210.

The schedule identifier 210 of the illustrated example uses the current location information obtained by the location identifier 208 to determine a broadcast time and a channel schedule when a program of interest is to be presented in the current location. In some examples, the broadcast time and the broadcast channel correspond to the current location serviced by a different broadcast area (e.g., area 107) than the home broadcast area (e.g., area 105) of the user 104. In the illustrated example, the schedule identifier 210 includes and/or is in communication with a database of broadcast information including broadcast times and broadcast channels for programs in various broadcast areas for use in identifying the appropriate local and/or current broadcast schedule to be pushed to the user 104. In some examples, the database 206 stores the broadcast information. In other examples, the broadcast information is stored remotely and/or accessed by the schedule identifier 210 to identify the broadcast time and channel of the program of interest to the user 104. In the illustrated example, once the schedule identifier 210 identifies the broadcast time and channel for the current location of the user 104, the schedule identifier 210 sends the broadcast information to the schedule pusher 212.

The schedule pusher 212 of the illustrated example pushes the broadcast time and an identifier of the channel for the current location to the mobile device 106 via the interface 202. The schedule pusher 212 of the illustrated example provides the broadcast information to the user 104 through, for example, an email, a pop-up window, a calendar alert, and/or a text message. The schedule pusher 212 may include a clock to identify a time to provide the presentation information to the mobile device 106 prior to the program broadcast. In some examples, the amount of time between the push of the presentation information to the mobile device 106 and the broadcast of the program may be a default time (or less if insufficient time remains) set by the schedule notifier 102. In other examples, the time may be selected by the user 104 during registration for the panel. For example, the registrar 204 may receive an indication from the user 104 that the schedule pusher 212 is to provide the presentation information to the mobile device 106 five minutes prior to the broadcast of the program, if possible. Other push times may, additionally or alternatively, be employed. Such push times may be shortened as needed. For example, if a user enters a new broadcast area when a program of interest is about to start or has already started, the notification may still be pushed to enable the user to tune to at least some of the program.

While an example manner of implementing the example schedule notifier 102 of FIG. 1 is illustrated in FIG. 2, one or more of the elements, processes and/or devices illustrated in FIG. 2 may be combined, divided, re-arranged, omitted, eliminated and/or implemented in any other way. Further, the example interface 202, the example registrar 204, the example database 206, the example geographic location identifier 208, the example schedule identifier 210, the example schedule pusher 212 and/or, more generally, the example schedule notifier 102 of FIG. 2 may be implemented by hardware, software, firmware and/or any combination of hardware, software and/or firmware. Thus, for example, any of the example interface 202, the example registrar 204, the example database 206, the example geographic location identifier 208, the example schedule identifier 210, the example schedule pusher 212 and/or, more generally, the example schedule notifier 102 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the system or apparatus claims of this patent are read to cover a purely software and/or firmware implementation, at least one of the example interface 202, the example registrar 204, the example database 206, the example geographic location identifier 208, the example schedule identifier 210, the example schedule pusher 212 and/or the example schedule notifier 102 are hereby expressly defined to include a tangible computer readable medium such as a memory, DVD, CD, etc. storing the software and/or firmware. Further still, the example schedule notifier 102 of FIG. 2 may include one or more elements, processes and/or devices in addition to, or instead of, those illustrated in FIG. 2, and/or may include more than one of any or all of the illustrated elements, processes and devices.

FIG. 3 is a block diagram of an example implementation of the media supplier 120 of FIG. 1. As described above, the media supplier 120 selects media, such as advertisements, related to the program(s) of interest to the user 104 of FIG. 1 to be provided to the user 104. The media supplier 120 of the illustrated example includes an interface 302, a media selector 304, and a media database 306.

The interface 302 of the illustrated example is used to facilitate communication between the media supplier 120 and one or more of the schedule notifier 102 and/or the mobile device 106 of FIGS. 1 and 2. In the illustrated example, the schedule notifier 102 sends identifier(s) of program(s) selected by the user 104 to the media supplier 120 via the interface 302. The interface 302 routes the identifier(s) to the media selector 304, a buffer, and/or the database 306.

The media selector 304 of the illustrated example is used to identify media related to the identifier(s) of the program(s) of interest and to provide advertisements related to the media and/or links to the media to the mobile device 106. Additionally or alternatively, the media selector 304 of the illustrated example may select media based on preference(s) of the user 104.

The media database 306 of the illustrated example contains media and/or links to the media which may be selected by the media selector 304. For example, the media database may store advertisements, coupons, trivia, and/or special offers that may be accessed by the media selector 304 to provide to the user 104. Additionally or alternatively, the media database 306 may contain URLs of advertisements, coupons, trivia, special offers, and/or websites.

The media selector 304 of the illustrated example provides the media and/or link(s) to the media from the media database 306 to the mobile device 106 via the interface 302. To provide the selected media to the user 104, the media selector 304 may, for example, provide the mobile device 106 with the URL of a website, stream the media, and/or send an email containing the URL to the mobile device 106. The media selector 304 may include a clock to facilitate sending the media, an identifier of the media, an offer to sell the media, and/or a link to the media to the mobile device 106 before, during, and/or after, for example, the broadcast of the identified program.

While an example manner of implementing the example media supplier 120 of FIG. 1 is illustrated in FIG. 3, one or more of the elements, processes and/or devices illustrated in FIG. 3 may be combined, divided, re-arranged, omitted, eliminated and/or implemented in any other way. Further, the example interface 302, the example media selector 304, the example media database 306 and/or, more generally, the example media supplier 120 of FIG. 3 may be implemented by hardware, software, firmware and/or any combination of hardware, software and/or firmware. Thus, for example, any of the example interface 302, the example media selector 304, the example media database 306 and/or, more generally, the example media supplier 120 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the system of apparatus claims of this patent are read to cover a purely software and/or firmware implementation, at least one of the example interface 302, the example media selector 304, the example media database 306 and/or the example media supplier 120 are hereby expressly defined to include a tangible computer readable medium such as a memory, DVD, CD, etc. storing the software and/or firmware. Further still, the example media supplier 120 of FIG. 3 may include one or more elements, processes and/or devices in addition to, or instead of, those illustrated in FIG. 3, and/or may include more than one of any or all of the illustrated elements, processes and devices.

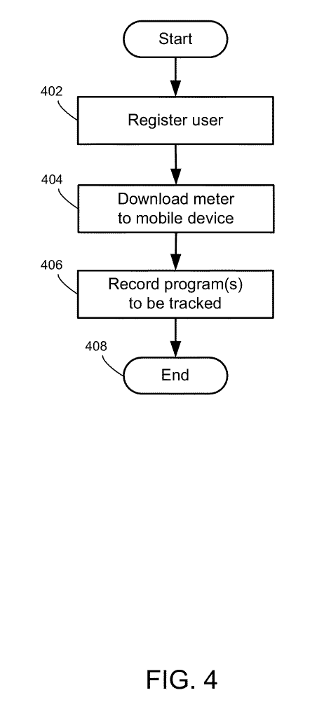

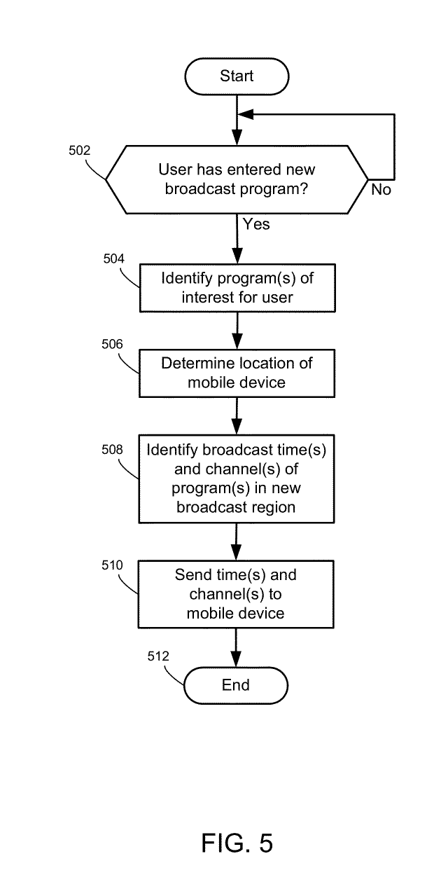

Flowcharts representative of example machine readable instructions for implementing the example schedule notifier 102 of FIG. 2 are shown in FIGS. 4 and 5. In these examples, the machine readable instructions comprise a program for execution by a processor such as the processor 702 shown in the example computing device 700 discussed below in connection with FIG. 7. The program may be embodied in software stored on a computer readable medium such as a CD-ROM, a floppy disk, a hard drive, a digital versatile disk (DVD), or a memory associated with the processor 702, but the entire program and/or parts thereof could alternatively be executed by a device other than the processor 702 and/or embodied in firmware or dedicated hardware. Further, although the example program is described with reference to the flowcharts illustrated in FIGS. 4 and 5, many other methods of implementing the example schedule notifier 102 may alternatively be used. For example, the order of execution of the blocks may be changed, and/or some of the blocks described may be changed, eliminated, or combined.

As mentioned above, the example processes of FIGS. 4 and 5 may be implemented using coded instructions (e.g., computer readable instructions) stored on a tangible computer readable medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes of FIGS. 4 and 5 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

A flowchart representative of example machine readable instructions for implementing the example registrar 204 of FIG. 2 is shown in FIG. 4. The registrar 204 of the illustrated example is provided to collect and store the demographic information of panelists, such as the user 104 of FIG. 1. Initially, the registrar 204 registers the user (block 402). In the illustrated example, registration of the user includes asking and/or requiring the user to provide demographic information to the registrar 204. Additionally, in the illustrated example, registration includes receiving permission from the user to monitor exposure to media, for example, on a mobile device associated with the user.

Once permission has been received from the user, the registrar 204 assigns a user identifier to the user (e.g., who is now a panelist) and/or their mobile device and downloads (or initiates downloading of) a meter 122 to the mobile device (block 404). The meter 122 is used to collect data (e.g., samples, metadata, program identification codes, signatures, etc.) of media which the mobile device has presented and/or been exposed to, such as, for example, radio programs, music, television programs, movies, and/or advertisements, and to send the data to a central facility 112 for further processing. In the illustrated example, the database 206 stores demographic information and/or media exposure data for the user in association with an identifier of the mobile device and/or the user.

To enable the schedule notifier to push information of interest to the user, the registrar 204 of the illustrated example identifies program(s) to be tracked (block 406). For example, a registration process may include asking the user to provide and/or identify a program (e.g., a radio or television program) of interest. The user may provide a title of a program of interest by typing in a title, selecting a title from a list, etc. Additionally or alternatively, the registrar 204 of the illustrated example may allow the user to provide and/or select an episode name of a program and/or a name of an actor to be tracked. At block 408, the registration process used by the registrar 204 of the illustrated example ends.

A flowchart representative of example machine readable instructions for implementing the example schedule notifier 102 of FIG. 2 is shown in FIG. 5. Once a user has registered (e.g., provided demographic information and/or given permission to be monitored), the registrar 204 of the illustrated example determines and/or indicates if the user has entered new program(s) to be tracked (block 502). For example, a user may register and/or identify a program to be tracked at the time of registering to participate in a panel and/or may later identify program(s) to be tracked. If the user has not entered new program(s) to be tracked, control remains at block 502. In the illustrated example, if the user has entered new program(s) to be tracked, the registrar 204 identifies the program(s) and sends the identifier(s) of the program(s) to the database 206 (block 504). The database 206 may then send the identifier(s) of the program(s) to be tracked to the location identifier 208.

The geographic location identifier 208 of the illustrated example determines the location of the mobile device (block 506). The geographic location identifier 208 may determine if the location of the mobile device is different than a home location of the user. The location identifier 208 may determine the location by communicating with a meter associated with the mobile device to receive GPS values from the mobile device. In some examples, the location identifier 208 is present on the mobile device 106 and/or is part of the meter. In some examples, the location data is transmitted whenever a sufficient change of location is detected (e.g., by comparing a current location to a home location). The location identifier 208 provides the current location information and the identifier(s) of the program(s) to be tracked to the schedule identifier 210.

The schedule identifier 210 of the illustrated example contains and/or has access to a database of broadcast information including broadcast times and broadcast channels for programs to be used to determine the local broadcast information for the identified program(s). The schedule identifier 210 identifies the broadcast time(s) and broadcast channel(s) of the identified program(s) in the user's current broadcast region (i.e., the current location of the mobile device) (block 508). The schedule identifier 210 provides the broadcast information to the schedule pusher 212.

The schedule pusher 212 of the illustrated example sends the broadcast time and an identifier of the broadcast channel for the current location to the mobile device (block 810). The broadcast information may be displayed on the mobile device without any user interaction via, for example, a pop-up window and/or a calendar alert. In other examples, the schedule pusher 212 may send a message, such as a text message or an email, containing the broadcast information. In the illustrated example, the schedule pusher 212 may provide the broadcast information to the user prior to the broadcast of the identified program(s). Control then returns to block 502.

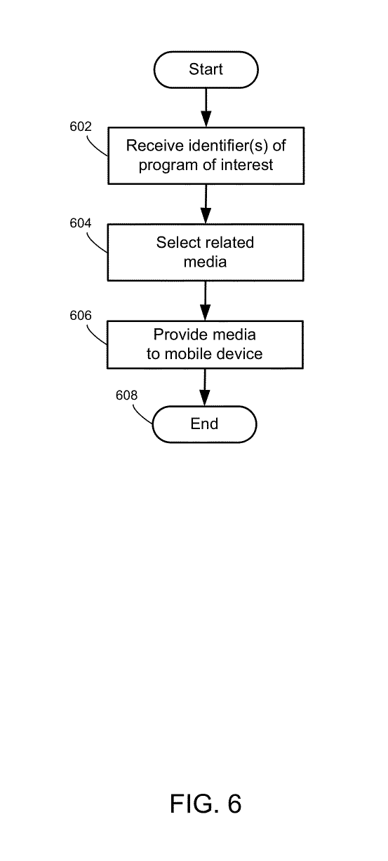

A flowchart representative of example machine readable instructions for implementing the media supplier 120 of FIG. 3 is shown in FIG. 6. In this example, the machine readable instructions comprise a program for execution by a processor such as the processor 702 shown in the example computing device 700 discussed below in connection with FIG. 7. The program may be embodied in software stored on a computer readable medium such as a CD-ROM, a floppy disk, a hard drive, a digital versatile disk (DVD), or a memory associated with the processor 702, but the entire program and/or parts thereof could alternatively be executed by a device other than the processor 702 and/or embodied in firmware or dedicated hardware. Further, although the example program is described with reference to the flowchart illustrated in FIG. 6, many other methods of implementing the example media supplier 120 may alternatively be used. For example, the order of execution of the blocks may be changed, and/or some of the blocks described may be changed, eliminated, or combined.

As mentioned above, the example processes of FIG. 6 may be implemented using coded instructions (e.g., computer readable instructions) stored on a tangible computer readable medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). Additionally or alternatively, the example processes of FIG. 6 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information).

In the example of FIG. 6, initially, the media selector 304 of the illustrated example receives identifier(s) of program(s) of interest tracked by the schedule notifier 102 (block 602). The media selector 304 of the illustrated example analyzes the program(s) and selects media related to the identified program(s) (block 604). Additionally or alternatively, the media selector 304 of the illustrated example may analyze the program(s) and select media based on one or more user preference(s). A user preference may be determined using previously identified program(s), genres of previously identified program(s), and/or previously identified actor(s) of interest. The media selected by the media selector 304 may include, for example, advertisements, coupons, trivia, and/or special offers related to the program(s) of interest.

The media selector 304 of the illustrated example provides the selected media and/or a link to the selected media to the mobile device of the user (block 606). The media selector 304 may, for example, provide the URL of the media (e.g., a website), stream the media, and/or send an email containing the URL to the mobile device. The media selector 304 may send the media, an identifier of the media, an offer to sell the media, and/or a link to the media to the mobile device before, during, and/or after the presentation of the identified program(s).

FIG. 7 is a block diagram of an example processing system 700 capable of executing the instructions of FIGS. 4-6 to implement the example register 203, the example schedule notifier 102, and the example media supplier 120 of FIGS. 2-3. The processing system 700 can be, for example, a server, a personal computer, an Internet appliance, a DVD player, a CD player, a digital video recorder, a personal video recorder, a set top box, or any other type of computing device.

The system 700 of the instant example includes a processor 712 such as a general purpose programmable processor. The processor 712 includes a local memory 714, and executes coded instructions 716 present in the local memory 714 and/or in another memory device. The processor 712 may execute, among other things, the machine readable instructions represented in FIGS. 4-6. The processor 712 may be any type of processing unit, such as one or more Intel® and/or ARM® microprocessors, and/or one or more PICO microcontrollers, etc. Of course, other processors from other families are also appropriate.

The processor 712 is in communication with a main memory including a volatile memory 718 and a non-volatile memory 720 via a bus 722. The volatile memory 718 may be implemented by Static Random Access Memory (SRAM), Synchronous Dynamic Random Access Memory (SDRAM), Dynamic Random Access Memory (DRAM), RAMBUS Dynamic Random Access Memory (RDRAM) and/or any other type of random access memory device. The non-volatile memory 720 may be implemented by flash memory and/or any other desired type of memory device. Access to the main memory 718, 720 is typically controlled by a memory controller (not shown).

The processing system 700 also includes an interface circuit 724. The interface circuit 724 may be implemented by any type of interface standard, such as an Ethernet interface, a universal serial bus (USB), and/or a third generation input/output (3GIO) interface.

One or more input devices 726 are connected to the interface circuit 724. The input device(s) 726 permit a user to enter data and commands into the processor 712. The input device(s) can be implemented by, for example, a keyboard, a mouse, a touchscreen, a track-pad, a trackball, an isopoint and/or a voice recognition system.

One or more output devices 728 are also connected to the interface circuit 724. The output devices 728 can be implemented, for example, by display devices (e.g., a liquid crystal display, a cathode ray tube display (CRT)), by a printer and/or by speakers. The interface circuit 724, thus, typically includes a graphics driver card.

The interface circuit 724 also includes a communication device such as a modem or network interface card to facilitate exchange of data with external computers via a network (e.g., an Ethernet connection, a digital subscriber line (DSL), a telephone line, coaxial cable, a cellular telephone system, etc.).

The processing system 700 also includes one or more mass storage devices 730 for storing machine readable instructions and data. Examples of such mass storage devices 730 include floppy disk drives, hard drive disks, compact disk drives, digital versatile disk (DVD) drives, flash drives, etc.

The coded instructions 732 of FIGS. 4-6 may be stored in the mass storage device 730, in the volatile memory 718, in the non-volatile memory 720, in the local memory 714 and/or on a removable storage medium, such as a CD or DVD 732.

As an alternative to implementing the methods and/or apparatus described herein in a system such as the processing system of FIG. 7, the methods and or apparatus described herein may be embedded in a structure such as a processor and/or an ASIC (application specific integrated circuit).

In examples disclosed herein, users are incentivized to join and/or remain in an audience measurement panel by receiving a benefit for staying in or joining such a panel. In particular, the user is provided with programming schedule(s) for program(s) of interest when the user travels to a new broadcasting area. In some examples, a location identifier determines if a current location of a mobile device associated with the user is different than a home location. In some examples, a schedule notifier uses the current location to determine a broadcast schedule for a program of interest. The schedule notifier relays the broadcast information for the current location to the user via the mobile device.

Although certain methods, apparatus, systems, and/or articles of manufacture have been described herein, the scope of coverage of this patent is not limited thereto. On the contrary, this patent covers all methods, apparatus, and articles of manufacture fairly falling within the scope of the appended claims either literally or under the doctrine of equivalents.

What is claimed is:

1. A method comprising:
if a current geographic location of a mobile device associated with a user is different from a home geographic location, determining a broadcast time and a channel schedule when a program of interest to the user is to be presented in the current location, the program of interest identified while the user is in the home location; and
pushing the broadcast time and an identifier of the broadcast channel of the program to the mobile device.

2. The method of claim 1, wherein the broadcast time and the identification of the broadcast channel are pushed to the mobile device prior to the broadcast time.

3. The method of claim 1, further comprising:
selecting media related to the program; and
providing the selected media or a link to the selected media to the mobile device.

4. The method of claim 3, wherein the selected media includes at least one of an advertisement, a coupon, or a special offer.

5. The method of claim 3, wherein providing the selected media comprises at least one of providing a uniform resource locator (URL) of a website, streaming the media, or sending an electronic mail message (email) containing the URL.

6. The method of claim 3, wherein selecting the media comprises selecting the media based on a user preference.

7. The method of claim 1, wherein determining the geographic location of the mobile device comprises accessing global positioning system (GPS) values on the mobile device and transmitting the GPS values to a remote device.

8. The method of claim 1, further comprising:
receiving permission from the user to monitor exposure to media;
downloading a meter to the mobile device; and
recording demographic information for the user in a database in association with an identifier of at least one of the mobile device or the user.

9. The method of claim 8, further comprising receiving an identifier of the program from the user, and storing the identifier of the program in association with the identifier of the at least one of the mobile device or the user.

10. The method of claim 8, wherein pushing the broadcast time and the identifier of the broadcast channel provides an incentive for the user to participate in an audience measurement panel.

11. The method of claim 8, further comprising receiving identifications of media to which the mobile device has been exposed.

12. The method of claim 8, further comprising detecting the program of interest based on data collected by the meter.

13. A system comprising:
a geographic location identifier to determine a current geographic location of a mobile device associated with a user;
a schedule identifier to determine a broadcast time and a channel on which a program of interest is to be broadcast in the current geographic location, the current location being different from the home location; and
a schedule pusher to push the broadcast time and an identifier of the broadcast channel of the program to the mobile device.

14. The system of claim 13, further comprising:
a media selector to select media related to the program; and
a media provider to provide the selected media or a link to the selected media to the mobile device.

15. The system of claim 14, wherein the selected media includes at least one of an advertisement, a coupon, or a special offer.

16. The system of claim 13, wherein determining the geographic location of the mobile device comprises accessing global positioning system (GPS) values collected on the mobile device.

17. The system of claim 13, further comprising:
a registrar to receive permission from the user to monitor exposure to media and to download a meter to the mobile device; and
a database to record demographic information for the user in association with an identifier of at least one of the mobile device or the user.

18. The system of claim 17, further comprising an interface to receive an identifier of the program from the user, and storing the identifier of the program in association with the identifier of the at least one of the mobile device or the user.

19. A tangible computer-readable storage medium comprising instructions that, when executed, cause a computing device to at least:
if a current geographic location of a mobile device associated with a user is different from a home geographic location, determine a broadcast time and a channel schedule when a program of interest to the user is to be presented in the current location, the program of interest identified while the user is in the home location; and
push the broadcast time and an identifier of the broadcast channel of the program to the mobile device.

20. The tangible computer-readable storage medium of claim 19, wherein the broadcast time and the identifier of the broadcast channel of the program are pushed to the mobile device prior to the broadcast time.

21. The tangible computer-readable storage medium of claim 19, further comprising instructions that, when executed, cause a computing device to:
select media related to the program; and
provide the selected media or a link to the selected media to the mobile device.

22. The tangible computer-readable storage medium of claim 21, wherein the selected media includes at least one of an advertisement, a coupon, or a special offer.

23. The tangible computer-readable storage medium of claim 21, wherein providing the media comprises at least one of providing a uniform resource locator (URL) of a website, streaming the media, or sending an electronic mail message (email) containing the URL.

24. The tangible computer-readable storage medium of claim 21, wherein selecting the media comprises selecting the media based on a user preference.

25. The tangible computer-readable storage medium of claim 19, wherein determining the geographic location of the mobile device comprises accessing global positioning system (GPS) values on the mobile device and transmitting the GPS values to a remote device.

26. The tangible computer-readable storage medium of claim 19, further comprising instructions that, when executed, cause a computing device to:
receive permission from the user to monitor exposure to media;
download a meter to the mobile device; and
record demographic information for the user in a database in association with an identifier of at least one of the mobile device or the user.

27. The tangible computer-readable storage medium of claim 26, further comprising instructions that, when executed, cause a computing device to receive an identifier of the program from the user, and storing the identifier of the program in association with the identifier of the at least one of the mobile device or the user.

28. The tangible computer-readable storage medium of claim 26, wherein pushing the broadcast time and the identifier of the broadcast channel provides an incentive for the user to participate in an audience measurement panel.

29. The tangible computer-readable storage medium of claim 26, further comprising instructions that, when executed, cause a computing device to receive identifications of media to which the mobile device has been exposed.

30. The tangible computer-readable storage medium of claim 26, further comprising instructions that, when executed, cause a computing device to detect the program of interest based on data collected by the meter.
